(19) United States
(12) Patent Application Publication
(10) Pub. No.: US 2001/0031716 A1
(43) Pub. Date: Oct. 18, 2001

(54) Detergent compositions

(76) Inventors: Gary Alan Grant, Bebington (GB); Amrat Paul Singh, Bebington (GB)

Correspondence Address: UNILEVER, PATENT DEPARTMENT, 45 RIVER ROAD, EDGEWATER, NJ, 07020, US

(21) Appl. No.: 09/778,226

(22) Filed: Feb. 7, 2001

(30) Foreign Application Priority Data
Feb. 7, 2000 (GB) 0002752.4

(51) Int. Cl. C11D 17/08

(52) U.S. Cl. 510/357; 510/422; 510/428; 510/490

(57) ABSTRACT

Laundry detergent compositions giving improved oily soil detergency in the machine wash, especially on knitted cotton and knitted polyviscose fabrics, contain an anionic sulphonate surfactant and a zwitterionic betaine surfactant in a weight ratio of 2:1 to 99:1, preferably 3:1 to 25:1. The preferred anionic surfactant is linear alkylbenzene sulphonate and the preferred betaine surfactant is cocoamidopropyl betaine.

### TECHNICAL FIELD

The present invention relates to wash processes and laundry detergent compositions containing a combination of anionic and betaine surfactants giving improved oily soil detergency, especially in the machine wash.

### BACKGROUND AND PRIOR ART

JP 05 247 495A (Dowa Yaku-So KK) discloses a solid detergent (tablet or powder) comprising anionic surfactant and cocoamidopropyl betaine in a ratio of 10:6-18.

WO 00/08129A (Unilever), published Feb. 17, 2000, discloses built particulate high-foaming laundry detergent compositions suitable for washing textile fabrics by hand, the compositions comprising from 10 to 25 wt % of high-foaming anionic surfactant, eg linear alkylbenzene sulphonate (LAS), and from 1 to 10 wt % of mild cosurfactant, the total amount of the two surfactants being from 18 to 28 wt %, preferably from 18 to 25 wt %, and the ratio of anionic surfactant to mild cosurfactant being from 1.5:1 to 20:1, preferably from 1.5:1 to 12:1. The compositions exhibit enhanced mildness to the skin, compared with all-LAS formulations, without loss of stain removal performance. The mild cosurfactant may be a betaine, preferably a C₈-C₁₈ alkyl amidoalkylbetaine, for example, coca amidopropyl betaine (CAPB).

GB 1 498 492 (Henkel) relates to laundry detergent compositions containing zeolite and a surfactant component comprising an amine oxide, carboxybetaine, sulphobetaine or alkyl ethoxy sulphate, and optionally an anionic sulphonate detergent. An example contains a carboxybetaine and an alkyl ethoxy sulphate together without sulphonate detergent.

GB 1 426 209 (Kao) discloses a high-foaming unbuilt dishwashing detergent composition which may contain, for example, alpha-olefin sulphonate and N-lauryl betaine.

EP 781 838A (Colgate-Palmolive) discloses liquid laundry detergent compositions containing, for example, cocoamidopropyl betaine, alkyl ethoxy sulphate and a nonionic surfactant.

EP 592 947A (Albright & Wilson) discloses industrial laundry liquids containing dissolved builder salts (eg sodium citrate, sodium carbonate) and a surfactant system comprising soap, ethoxylated nonionic surfactant and an anionic and/or amphoteric surfactant. An example contains soap, linear alkylbenzene sulphonate and alkyl dimethyl betaine.

EP 551 991A (Unilever) discloses mild hand dishwashing detergent compositions in liquid or gel form containing primary alkyl sulphate plus betaine and/or amine oxide.

EP 72 509A (Henkel) discloses liquid laundry detergent compositions containing a surfactant mixture of sulphobetaine and olefin sulphonate.

WO 96/01306A (Procter & Gamble) discloses a built laundry powder for the hand wash containing an anionic surfactant (eg alkyl ethoxy sulphate), an ethoxylated nonionic surfactant, a polyhydroxy fatty acid amide nonionic surfactant and an amine oxide in specified ratios. Two examples disclose compositions also containing cocoamidopropyl betaine.

GB 1 065 460 (Henkel) discloses dishwashing detergent compositions containing a sulphate or sulphonate anionic surfactant and a sulphobetaine.

EP 232 153A (Unilever) discloses a liquid dishwashing detergent composition containing alkyl ethoxy sulphate, a lather booster which may be a betaine, and an ethoxylated nonionic surfactant.

WO 99/19428A (Procter & Gamble) discloses betaines as possible optional ingredients (not exemplified) in solid laundry detergent compositions containing anionic mid-branched surfactant compounds and additional anionic sulphate and sulphonate surfactants.

WO 98/50507A (Colgate-Palmolive) discloses unbuilt high-foaming light-duty liquid laundry detergent compositions containing a nonionic surfactant, a foaming anionic surfactant, a betaine, a monoalkanolamide, a dialkanolamide and a monoalkyl phosphate ester.

The present invention is based on the discovery that, in the machine wash, betaine surfactants, in relatively small amounts in combination with larger amounts of specified anionic surfactants, give significantly enhanced removal of oily soils, particularly on knitted fabrics and polyviscose fabrics.

### DEFINITION OF THE INVENTION

A first aspect of the present invention provides a process for removing oily soil from textile fabrics, which comprises laundering the soiled fabrics in a washing machine in a wash liquor containing an effective amount of a laundry detergent composition containing an anionic sulphonate surfactant and a betaine surfactant in a weight ratio within the range of from 2:1 to 99:1.

A second aspect of the invention provides a process for removing oily soil from textile fabrics other than woven cotton or polycotton, which comprises laundering the soiled fabrics by hand or machine in a wash liquor containing an effective amount of a laundry detergent composition containing an anionic sulphonate surfactant and a betaine surfactant in a weight ratio within the range of from 2:1 to 99:1.

A third aspect of the invention provides a built particulate laundry detergent composition suitable for laundering textile fabrics in a washing machine, comprising

(a) from 4 to 25 wt % of an anionic sulphonate surfactant,

(b) from 0.2 to 10 wt % of a betaine surfactant,

(c) optionally up to 10 wt % of other surfactants, the weight ratio of anionic surfactant (a) to betaine surfactant (b) being from 2:1 to 99:1,

(d) from 10 to 80 wt % of detergency builder,

(e) an effective amount of a foam control agent, and optionally other detergent ingredients to 100 wt %.

A fourth aspect of the invention provides a built particulate laundry detergent composition comprising

(a) from 4 to less than 10 wt % of an anionic sulphonate surfactant,

(b) from 0.2 to 10 wt % of a betaine surfactant,

(c) optionally up to 10 wt % of other surfactants, the weight ratio of anionic surfactant (a) to betaine surfactant (b) being from 2:1 to 99:1,

(d) from 10 to 80 wt % of detergency builder, and optionally other detergent ingredients to 100 wt %.

### DETAILED DESCRIPTION OF THE INVENTION

The processes and compositions of the invention require a laundry detergent composition having a surfactant system which comprises a major amount of an anionic sulphonate surfactant and a minor amount of a betaine surfactant. In the compositions of the invention, the weight ratio of anionic sulphonate surfactant (a) to betaine surfactant (b) is from 2:1 to 99:1. Especially good results are obtained when the ratio is within the range of from 3:1 to 25:1, more especially 4:1 to 20:1.

### The Wash Processes

According to the invention textile fabrics may be washed by hand or by machine, but the invention is especially concerned with the machine wash.

The surfactant combination used in the processes of the invention has been found to give synergistic removal of oily soils, more especially liquefied oily soils such as mechanical and kitchen grease, from fabrics. Especially good results have been obtained on polyviscose fabric, particularly knitted polyviscose, which is widely used in certain Latin American countries, and on other knitted fabrics, for example, knitted cotton.

Compositions of the invention are preferably used at a product concentration of from 0.5 to 5 g/liter, more preferably from 1 to 3 g/liter. The preferred dose will depend on the total level of surfactant in the composition, but should aim to give a surfactant concentration in the wash liquor of from 0.1 to 1 g/liter, preferably from 0.2 to 0.5 g/liter.

### The Anionic Sulphonate Surfactant

Anionic sulphonate surfactants are well-known to those skilled in the art. Examples include alkylbenzene sulphonates; olefin sulphonates; alkyl xylene sulphonates; dialkyl sulphosuccinates; and fatty acid ester sulphonates. Sodium salts are generally preferred.

Preferably the anionic surfactant is linear alkylbenzene sulphonate. More preferably the anionic surfactant is linear alkylbenzene sulphonate.

The anionic sulphonate surfactant is preferably present in an amount of from 4 to 25 wt %, more preferably from 4 to 15 wt %. In the machine wash excess foaming is not desirable. The amount of foaming may be controlled by the incorporation of a foam control agent. Suitable foam control agents include soap, preferably included in an amount of from 1 to 5 wt %; nonionic surfactants, preferably included in an amount of from 2 to 10 wt %; and combinations of the two.

Other foam control agents include hydrocarbon waxes, petroleum jelly, or silicone oils. Liquid or jelly foam control agents may be in the form of granules containing a particulate carrier material, for example, a starch or an inorganic salt such as light soda ash. An especially preferred foam control granule comprises silicone oil, optionally in admixture with a finely divided hydrophobic silica, on a particulate inorganic carrier material, preferably light soda ash. Foam control granules are widely disclosed in the art and are well-known to the skilled practitioner.

Where the wash process is to be carried out in in a top-loading washing machine, the foam control requirements are less stringent. Compositions containing, for example, from 4 to less than 10 wt % of anionic surfactant may not need to contain a foam control agent.

### The Betaine Surfactant

Betaines are materials of the general formula I:

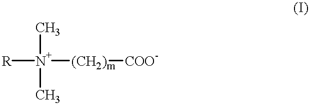

wherein R is a hydrocarbon chain containing 8 to 20 carbon atoms, optionally interrupted by an amide group, and m is an integer from 1 to 4.

Preferred betaines are materials of the general formula Ia:

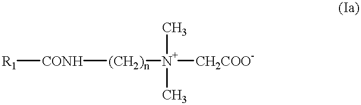

wherein R₁ is a C₈-C₁₈ alkyl group, and n is an integer of from 2 to 4.

In an especially preferred compound, R₁ is a C₁₂-C₁₄ alkyl group and n is 3. This compound is coco-amidopropyl betaine (CAPB).

In the detergent compositions of the invention, the betaine surfactant is present in an amount of from 0.2 to 10 wt %, preferably from 0.5 to 5 wt %, more preferably from 0.8 to 3 wt %.

### Other Surfactants

If desired, other surfactants may be present in the compositions of the invention, in amounts of up to 10 wt %.

Where another surfactant is present, it is preferably a nonionic surfactant, more preferably an ethoxylated nonionic surfactant.

As indicated previously, nonionic surfactants may be included in the compositions and may act to control foam as well as to improve detergency. Nonionic surfactants that may be used include the primary and secondary alcohol ethoxylates, especially the C₈-C₂₀ aliphatic alcohols ethoxylated with an average of from 1 to 20 moles of ethylene oxide per mole of alcohol, and more especially the C₁₀-C₁₅ primary and secondary aliphatic alcohols ethoxylated with an average of from 1 to 10 moles of ethylene oxide per mole of alcohol. Non-ethoxylated nonionic surfactants include alkylpolyglycosides, glycerol monoethers, and polyhydroxyamides (glucamide).

Many suitable detergent-active compounds are available and are fully described in the literature, for example, in “Surface-Active Agents and Detergents”, Volumes I and II, by Schwartz, Perry and Berch.

### Preferred Compositions

A first preferred composition according to the invention is a built particulate laundry detergent composition suitable for laundering textile fabrics in a washing machine, comprising

(a) from 4 to 25 wt %, preferably from 5 to 15 wt %, of an anionic sulphonate surfactant, preferably linear alkylbenzene sulphonate;

(b) from 0.2 to 10 wt %, preferably from 0.5 to 5 wt %, more preferably from 0.8 to 3 wt %, of a betaine surfactant;

(c) optionally up to 10 wt % of other surfactants; the weight ratio of anionic sulphonate surfactant (a) to betaine surfactant (b) being from 2:1 to 99:1, preferably from 3:1 to 25:1, more preferably from 4:1 to 20:1;

(d) from 10 to 80 wt % of detergency builder;

(e) an effective amount of a foam control agent;

and optionally other detergent ingredients to 100 wt %.

Component (c), if present, is preferably an ethoxylated nonionic surfactant.

The foam control agent (e) preferably comprises from 1 to 5 wt % of soap and/or from 2 to 10 wt % of nonionic surfactant and/or from 1 to 5 wt % of granules comprising a silicone oil on a particulate carrier material.

A second preferred composition according to the invention is a built particulate laundry detergent composition comprising

(a) from 4 to less than 10 wt % of an anionic sulphonate surfactant, preferably linear alkylbenzene sulphonate;

(b) from 0.2 to 10 wt %, preferably from 0.5 to 5 wt %, more preferably from 0.8 to 3 wt %, of a betaine surfactant,

(c) optionally up to 10 wt % of other surfactants,

the weight ratio of anionic sulphonate surfactant (a) to betaine surfactant (b) being from 2:1 to 99:1, preferably from 3:1 to 25:1, more preferably from 4:1 to 20:1,

(d) from 10 to 80 wt % of detergency builder,

and optionally other detergent ingredients to 100 wt %.

Component (c), if present, is preferably an ethoxylated nonionic surfactant.

### Detergent Ingredients

As well as the surfactants discussed above, the compositions preferably contain detergency builders, and may optionally contain bleaching components and other active ingredients to enhance performance and properties.

The compositions may suitably contain from 10 to 80%, preferably from 15 to 70% by weight, of detergency builder. Preferably, the quantity of builder is in the range of from 15 to 50% by weight.

The detergent compositions may contain as builder a crystalline aluminosilicate, preferably an alkali metal aluminosilicate, more preferably a sodium aluminosilicate (zeolite).

The zeolite used as a builder may be the commercially available zeolite A (zeolite 4A) now widely used in laundry detergent powders. Alternatively, the zeolite may be maximum aluminium zeolite P (zeolite MAP) as described and claimed in EP 384 070B (Unilever), and commercially available as Doucil (Trade Mark) A24 from Crosfield Chemicals Ltd, UK. Zeolite MAP is defined as an alkali metal aluminosilicate of zeolite P type having a silicon to aluminium ratio not exceeding 1.33, preferably within the range of from 0.90 to 1.33, preferably within the range of from 0.90 to 1.20.

Especially preferred is zeolite MAP having a silicon to aluminium ratio not exceeding 1.07, more preferably about 1.00. The particle size of the zeolite is not critical. Zeolite A or zeolite MAP of any suitable particle size may be used.

Also preferred according to the present invention are phosphate builders, especially sodium tripolyphosphate. This may be used in combination with sodium orthophosphate, and/or sodium pyrophosphate.

Other inorganic builders that may be present additionally or alternatively include sodium carbonate, layered silicate, amorphous aluminosilicates.

Organic builders that may be present include polycarboxylate polymers such as polyacrylates and acrylic/maleic copolymers; polyaspartates; monomeric polycarboxylates such as citrates, gluconates, oxydisuccinates, glycerol mono-di-and trisuccinates, carboxymethyloxysuccinates, carboxymethyloxymalonates, dipicolinates, hydroxyethyliminodiacetates, alkyl- and alkenylmalonates and succinates; and sulphonated fatty acid salts. Organic builders may be used in minor amounts as supplements to inorganic builders such as phosphates and zeolites. Especially preferred supplementary organic builders are citrates, suitably used in amounts of from 5 to 30 wt %, preferably from 10 to 25 wt %; and acrylic polymers, more especially acrylic/maleic copolymers, suitably used in amounts of from 0.5 to 15 wt %, preferably from 1 to 10 wt %.

Builders, both inorganic and organic, are preferably present in alkali metal salt, especially sodium salt, form. Detergent compositions according to the invention may also suitably contain a bleach system. The bleach system is preferably based on peroxy bleach compounds, for example, inorganic persalts or organic peroxyacids, capable of yielding hydrogen peroxide in aqueous solution. Suitable peroxy bleach compounds include organic peroxides such as urea peroxide, and inorganic persalts such as the alkali metal perborates, percarbonates, perphosphates, persilicates and persulphates. Preferred inorganic persalts are sodium perborate monohydrate and tetrahydrate, and sodium percarbonate. Especially preferred is sodium percarbonate having a protective coating against destabilisation by moisture. Sodium percarbonate having a protective coating comprising sodium metaborate and sodium silicate is disclosed in GB 2 123 044B (Kao).

The peroxy bleach compound is suitably present in an amount of from 5 to 35 wt %, preferably from 10 to 25 wt %.

The peroxy bleach compound may be used in conjunction with a bleach activator (bleach precursor) to improve bleaching action at low wash temperatures. The bleach precursor is suitably present in an amount of from 1 to 8 wt %, preferably from 2 to 5 wt %.

Preferred bleach precursors are peroxycarboxylic acid precursors, more especially peracetic acid precursors and peroxybenzoic acid precursors; and peroxycarbonic acid precursors. An especially preferred bleach precursor suitable for use in the present invention is N,N,N′,N′-tetracetyl ethylenediamine (TAED). Also of interest are peroxybenzoic acid precursors, in particular, N,N,N-trimethylammonium toluoyloxy benzene sulphonate.

A bleach stabiliser (heavy metal sequestrant) may also be present. Suitable bleach stabilisers include ethylenediamine tetraacetate (EDTA) and the polyphosphonates such as Dequest (Trade Mark), EDTMP.

The detergent compositions may also contain one or more enzymes. Suitable enzymes include the proteases, amylases, cellulases, oxidases, peroxidases and lipases usable for incorporation in detergent compositions. Detergency enzymes are commonly employed in granular form in amounts of from about 0.1 to about 3.0 wt %. However, any suitable physical form of enzyme may be used in any effective amount.

Antiredeposition agents, for example cellulose esters and ethers, for example sodium carboxymethyl cellulose, may also be present.

The compositions may also contain soil release polymers, for example sulphonated and unsulphonated PET/POET polymers, both end-capped and non-end-capped, and polyethylene glycol/polyvinyl alcohol graft copolymers such as Sokolan (Trade Mark) HP22. Especially preferred soil release polymers are the sulphonated non-end-capped polyesters described and claimed in WO 95 32997A (Rhodia Chimie).

Other ingredients that may be present include solvents, hydrotropes, fluorescers, photobleaches, sodium carbonate, sodium bicarbonate, sodium silicate, sodium sulphate, calcium chloride, other inorganic salts, fabric conditioning compounds, and perfumes.

A typical detergent composition according to the invention may comprise:

(i) from 5 to 40 wt % of total non-soap surfactant,

(ii) from 10 to 80 wt % of detergency builder,

(iii) optionally from 1 to 5 wt % of soap,

(iv) optionally from 1 to 5 wt % of foam control granules,

(iv) optionally from 1 to 30 wt % of sodium carbonate,

(v) optionally from 1 to 30 wt % of bleaching ingredients,

(vi) optionally one or more detergency enzymes,

(vii) optionally other detergent ingredients to 100 wt %.

The other ingredients that may be present are preferably selected from fluorescers, photobleaches, antiredeposition agents, soil release agents, sodium sulphate, sodium silicate, sodium bicarbonate, perfumes and fabric conditioning agents.

### Product Form and Preparation

The compositions of the invention are in particulate form. Particulate detergent compositions comprise powders, and tablets of compacted powder.

The compositions of the invention are most preferably in powder form.

Powders of low to moderate bulk density may be prepared by spray-drying a slurry, and optionally postdosing (dry-mixing) further ingredients. “Concentrated” or “compact” powders may be prepared by mixing and granulating processes, for example, using a high-speed mixer/granulator, or other non-tower processes.

### EXAMPLES

The invention is illustrated in further detail by the following non-limiting Examples, in which parts and percentages are by weight unless otherwise stated.

### Examples 1 to 8, Comparative Examples A and B

### Performance Appraisal of Anionic Sulphonate Surfactant/Betaine Surfactant Mixtures on Kitchen Grease Soil

Surfactant mixtures were prepared by mixing linear alkylbenzene sulphonate (LAS) and cocoamidopropyl betaine (CAPB) in various proportions ranging from 95:5 (19:1) to 80:20 (4:1).

Three detergent compositions were prepared to the following formulations (parts by weight):

| Ingredient | X | Y | Z |
|---|---|---|---|
| Total surfactant | 9.8 | 15.8 | 24.0 |
| (LAS plus CAPB) | | | |
| Sodium tripolyphosphate | 25.0 | 34.0 | 2.4 |
| Sodium sulphate | 23.0 | — | 14.0 |
| Sodium carbonate | 6.3 | 3.6 | 15.0 |
| Sodium silicate | 9.0 | 7.0 | 7.0 |

Soil removal performance on knitted cotton and knitted polyviscose fabrics was measured in a tergotometer test. The soil used was soya bean oil (chosen as a typical greasy kitchen soil), coloured with a violet dye (0.08 wt %) to act as a visual indicator.

Test cloths (10 cm×10 cm), each soiled with 0.5 ml of violet-dyed soya bean oil, were washed in tergotometers using the detergent compositions above under the following conditions:

| Conditions | Composition X | Composition Y | Composition Z |
|---|---|---|---|
| Temperature | 25° C. | 25° C. | 25° C. |
| Liquor to | 30:1 | 30:1 | 30:1 |
| cloth ratio | | | |
| Product dosage | 3.0 g/l | 1.8 g/l | 2.0 g/l |
| Water hardness | 19 | 40 | 6 |
| (° French) | | | |
| Soak time | — | — | 10 min |
| Wash time | 25 min | 15 min | 15 min |
| (agitation) | | | |

The reflectance ΔE, indicative of total colour change (of the violet dye) across the whole visible spectrum, of each test cloth was measured before and after the wash. The results expressed as ΔΔΔE (the difference ΔΔE between reflectance values ΔE before and after the wash, compared with the 100% LAS control) are shown in the following table. These results are averaged over 8 replicates.

### Knitted Polyviscose

ΔΔΔE

| | | Composition Z | Composition X |
|---|---|---|---|
| Ex. | LAS:CAPB | LSD = 1.1 | LSD = 1.0 |
| A | 100:0 | (0) | (0) |
| 1 | 95:5 | +2.4 | +0.7 |
| 2 | 90:10 | +0.8 | +0.1 |
| 3 | 85:15 | +1.0 | +0.4 |
| 4 | 80:20 | +2.2 | −1.0 |

### Knitted Cotton

| | | ΔΔΔE | | |
|---|---|---|---|---|
| | | Composition X | Composition Y | Composition Z |
| Ex. | LAS:CAPB | LSD = 1.5 | LSD = 2.9 | LSD = 1.3 |
| B | 100:0 | (0) | (0) | (0) |
| 5 | 95:5 | +1.9 | +4.3 | +1.5 |
| 6 | 90:10 | +2.3 | +3.5 | +3.1 |
| 7 | 85:15 | +1.8 | +2.4 | +3.0 |
| 8 | 80:20 | +0.6 | −3.5 | +2.8 |

### Examples 9 to 16, Comparative Examples C and D

### Performance Appraisal of LAS/Betaine Mixtures on Mechanical Grease

Detergency on a different soil, mechanical grease (paraffinic oil with particulate iron and carbon dispersed therein), was assessed using the same fabrics and the same formulations (X, Y and Z) and the same wash conditions (per formulation) as were used in Examples 1 to 8. No indicator dye was needed because the soil was itself sufficiently coloured by the presence of the particulate material.

The reflectance results (each averaged over 8 replicates) were as follows:

### Knitted polyviscose

ΔΔΔE

| | | Composition X | Composition Z |
|---|---|---|---|
| Ex. | LAS:CAPB | LSD = 2.9 | LSD = 2.2 |
| C | 100:0 | (0) | (0) |
| 9 | 95:5 | +0.7 | +1.9 |
| 10 | 90:10 | +1.1 | +2.3 |
| 11 | 85:15 | +1.3 | +3.7 |
| 12 | 80:20 | +1.0 | +3.9 |

### Knitted Cotton

| | | ΔΔΔE | | |
|---|---|---|---|---|
| | | Composition X | Composition Y | Composition Z |
| Ex. | LAS:CAPB | LSD = 1.9 | LSD = 2.5 | LSD = 1.8 |
| D | 100:0 | (0) | (0) | (0) |
| 13 | 95:5 | −0.7 | +0.9 | +1.5 |
| 14 | 90:10 | +0.7 | +0.9 | +1.9 |
| 15 | 85:15 | +0.4 | +0.3 | +2.0 |
| 16 | 80:20 | +1.5 | −0.8 | +2.1 |

### Examples 17 to 28

### Particulate Laundry Detergent Compositions

### Examples 17 to 20

### Low-Foaming Powder Formulations For Use in Drum-Type Automatic Washing Machines

| Ingredient | 17 | 18 | 19 | 20 |
|---|---|---|---|---|
| LAS | 5.8 | 5.4 | 8.8 | 7.8 |
| Nonionic 7EO | 3.4 | 3.4 | — | — |
| CAPB | 0.6 | 1.0 | 1.0 | 2.0 |

| | |
|---|---|
| STP¹ | 25.0 |
| Na carbonate | 6.3 |
| Na sulphate | 23.0 |
| Na silicate | 9.0 |
| Soil release | 0.7 |
| polymer | |
| Na perborate | 5.84 |
| TAED² | 2.28 |
| Enzymes³ | 1.32 |
| Antifoam granules | 2.0 |
| Water + minors | to 100 |

¹Sodium tripolyphosphate
²Tetracetylethylenediamine
³Protease, lipase, amylase

### Examples 21 to 24

### Powder Formulations Suitable For Both Top-Loading and Drum-Type Washing Machines

| Ingredient | 21 | 22 | 23 | 24 |
|---|---|---|---|---|
| LAS | 10.5 | 10.0 | 9.5 | 9.0 |
| Nonionic 7EO | 5.0 | 5.0 | 5.0 | 5.0 |
| CAPB | 0.5 | 1.0 | 1.5 | 2.0 |

| | |
|---|---|
| STP | 34.0 |
| Na carbonate | 3.7 |
| Na silicate | 7.0 |
| SCMC¹ | 0.5 |
| Soil release | 0.35 |
| polymer | |
| Na perborate | 7.7 |
| TAED² | 2.2 |
| Enzymes³ | 1.79 |
| Fluorescer | 0.15 |
| Water + minors | to 100 |

¹Sodium carboxymethyl cellulose
²Tetracetylethylenediamine
³Protease, lipase, amylase, cellulase

### Examples 25 to 28

### Powder Formulations Suitable For Both Top-Loading Machine Use and Handwash Use

| Ingredient | 25 | 26 | 27 | 28 |
|---|---|---|---|---|
| LAS | 23.0 | 22.0 | 21.0 | 20.0 |
| CAPB | 1.0 | 2.0 | 2.0 | 3.0 |

| | |
|---|---|
| STP | 19.0 |
| Na carbonate | 15.0 |
| Na sulphate | 14.0 |
| Na silicate | 7.0 |
| SCMC¹ | 0.37 |
| Acrylate/maleate | 1.5 |
| copolymer | |
| Na perborate | 8.0 |
| TAED² | 2.4 |
| Enzymes³ | 1.7 |
| Fluorescer | 0.19 |
| Water + minors | to 100 |

¹Sodium carboxymethyl cellulose
²Tetracetylethylenediamine
³Protease, lipase, amylase

We claim:

1. A process for removing oily soil from textile fabrics, which comprises laundering the soiled fabrics in a washing machine in a wash liquor containing an effective amount of a laundry detergent composition containing an anionic sulphonate surfactant and a betaine surfactant in a weight ratio within the range of from 2:1 to 99:1.

2. A process for removing oily soil from textile fabrics other than woven cotton or polycotton, which comprises laundering the soiled fabrics by hand or machine in a wash liquor containing an effective amount of a laundry detergent composition containing an anionic sulphonate surfactant and a betaine surfactant in a weight ratio within the range of from 2:1 to 99:1.

3. A process as claimed in claim 2, wherein the fabric is a knitted fabric selected from knitted polyviscose and knitted cotton.

4. A process as claimed in claim 2, wherein the fabric is polyviscose.

5. A process as claimed in claim 1, wherein the betaine surfactant is a compound of the formula I 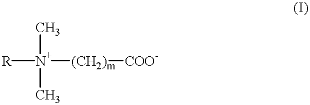
wherein R is a hydrocarbon chain containing 8 to 20 carbon atoms, optionally interrupted by an amide group, and m is an integer from 1 to 4.

6. A process as claimed in claim 5, wherein the betaine surfactant is a compound of the general formula Ia: 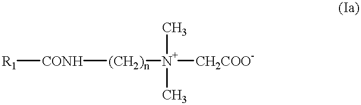
wherein R₁ is a C₈-C₁₈ alkyl group, and n is an integer of from 2 to 4.

7. A process as claimed in claim 6, wherein the betaine surfactant is a compound of the formula Ia wherein R₁ is a C₁₂-C₁₄ alkyl group and n is 3.

8. A process as claimed in claim 1, wherein the anionic sulphonate surfactant is linear alkylbenzene sulphonate.

9. A process as claimed in claim 1, wherein the ratio of anionic surfactant to betaine surfactant is within the ratio of from 3:1 to 25:1, preferably from 4:1 to 20:1.

10. A built particulate laundry detergent composition suitable for laundering textile fabrics in a washing machine, comprising
(a) from 4 to 25 wt % of an anionic sulphonate surfactant,
(b) from 0.2 to 10 wt % of a betaine surfactant,
(c) optionally up to 10 wt % of other surfactants, the weight ratio of anionic surfactant (a) to betaine surfactant (b) being from 2:1 to 99:1,
(d) from 10 to 80 wt % of detergency builder,
(e) an effective amount of a foam control agent, and optionally other detergent ingredients to 100 wt %.

11. A detergent composition as claimed in claim 10, comprising
(a) from 4 to 25 wt % of an anionic sulphonate surfactant,
(b) from 0.2 to 10 wt % of a betaine surfactant,
(c) optionally up to 10 wt % of an ethoxylated nonionic surfactant,
the weight ratio of anionic sulphonate surfactant (a) to betaine surfactant (b) being from 2:1 to 99:1,
(d) from 10 to 80 wt % of detergency builder,
(e) an effective amount of a foam control agent,
and optionally other detergent ingredients to 100 wt %.

12. A detergent composition as claimed in claim 10, which comprises from 4 to 15 wt % of the anionic surfactant (a).

13. A detergent composition as claimed in claim 10, wherein the foam control agent comprises from 1 to 5 wt % of soap and/or from 2 to 10 wt % of nonionic surfactant and/or from 1 to 5 wt % of granules comprising a silicone oil on a particulate carrier material.

14. A detergent composition as claimed in claim 10, wherein the betaine surfactant is present in an amount of from 0.5 to 5 wt %, preferably from 0.8 to 3 wt %.

15. A detergent composition as claimed in claim 10, wherein the betaine surfactant is a compound of the formula I 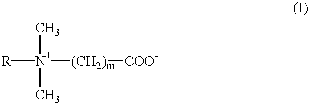
wherein R is a hydrocarbon chain containing 8 to 20 carbon atoms, optionally interrupted by an amide group, and m is an integer from 1 to 4.

16. A detergent composition as claimed in claim 15, wherein the betaine surfactant is a compound of the general formula Ia: 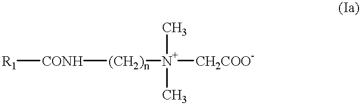
wherein R₁ is a C₈-C₁₈ alkyl group, and n is an integer of from 2 to 4.

17. A detergent composition as claimed in claim 16, wherein the betaine surfactant is a compound of the formula Ia wherein R₁ is a C₁₂-C₁₄ alkyl group and n is 3.

18. A detergent composition as claimed in claim 10, wherein the weight ratio of anionic sulphonate surfactant to betaine is from 3:1 to 25:1, preferably from 4:1 to 20:1.

19. A detergent composition as claimed in claim 10, wherein the anionic sulphonate surfactant is linear alkylbenzene sulphonate.

20. A detergent composition as claimed in claim 10, which further comprises any one or more ingredients selected from the group consisting of: sodium carbonate, bleaching ingredients, detergency enzymes, fluorescers, photobleaches, antiredeposition agents, soil release agents, sodium sulphate, sodium silicate, sodium bicarbonate, perfumes and fabric conditioning agents.

21. A built particulate laundry detergent composition comprising
(a) from 4 to less than 10 wt % of an anionic sulphonate surfactant,
(b) from 0.2 to 10 wt % of a betaine surfactant,
(c) optionally up to 10 wt % of other surfactants, the weight ratio of anionic surfactant (a) to betaine surfactant (b) being from 2:1 to 99:1,
(d) from 10 to 80 wt % of detergency builder,
and optionally other detergent ingredients to 100 wt %.

22. A detergent composition as claimed in claim 21, comprising
(a) from 4 to less than 10 wt % of an anionic sulphonate surfactant,
(b) from 0.2 to 10 wt % of a betaine surfactant,
(c) optionally up to 10 wt % of ethoxylated nonionic surfactant,
the weight ratio of anionic surfactant (a) to betaine surfactant (b) being from 2:1 to 99:1,
(d) from 10 to 80 wt % of detergency builder,
and optionally other detergent ingredients to 100 wt %.

23. A detergent composition as claimed in claim 21, wherein the betaine surfactant is present in an amount of from 0.5 to 5 wt %, preferably from 0.8 to 3 wt %.

24. A detergent composition as claimed in claim 21, wherein the betaine surfactant is a compound of the formula I 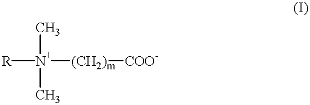
wherein R is a hydrocarbon chain containing 8 to 20 carbon atoms, optionally interrupted by an amide group, and m is an integer from 1 to 4.

25. A detergent composition as claimed in claim 24, wherein the betaine surfactant is a compound of the general formula Ia: 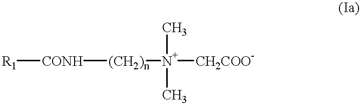
wherein R₁ is a C₈-C₁₈ alkyl group, and n is an integer of from 2 to 4.

26. A detergent composition as claimed in claim 25, wherein the betaine surfactant is a compound of the formula Ia wherein R₁ is a C₁₂-C₁₄ alkyl group and n is 3.

27. A detergent composition as claimed in claim 21, wherein the weight ratio of anionic sulphonate surfactant to betaine is from 3:1 to 25:1, preferably from 4:1 to 20:1.

28. A detergent composition as claimed in claim 21, wherein the anionic sulphonate surfactant is linear alkylbenzene sulphonate.

29. A detergent composition as claimed in claim 21, which further comprises any one or more ingredients selected from the group consisting of: sodium carbonate, bleaching ingredients, detergency enzymes, fluorescers, photobleaches, antiredeposition agents, soil release agents, sodium sulphate, sodium silicate, sodium bicarbonate, perfumes and fabric conditioning agents.
